(19) United States
(12) Patent Application Publication
(10) Pub. No.: US 2012/0138390 A1
(43) Pub. Date: Jun. 7, 2012

(54) ELEVATOR SYSTEM AND METHOD FOR CONTROLLING THE SAME

(75) Inventor: Yoshimasa Koba, Tokyo (JP)

(73) Assignee: Mitsubishi Electric Corporation, Tokyo (JP)

(21) Appl. No.: 13/389,454

(22) PCT Filed: Aug. 27, 2009
(86) PCT No.: PCT/JP09/04152

§ 371 Date: Feb. 8, 2012

(51) Int. Cl. B66B 1/28

(52) U.S. Cl. 187/247

(57) ABSTRACT

An elevator system including a push button type hall operating panel that allows a user to make destination floor call registration in an elevator hall, and a method for controlling the elevator system. To perform a special operation for a special user at a low cost, the hall operating panel includes a function button as a button for changeover between a mode of inputting a destination floor during a normal operation and a mode of inputting an ID number used to execute the special operation. The ID number is inputted by a destination floor input section, and the special operation related to the inputted ID number is executed.

### TECHNICAL FIELD

The present invention relates to an elevator system provided with a hall operating panel in an elevator hall and a method for controlling the elevator system.

### BACKGROUND ART

Some conventional elevator systems are provided with a hall operating panel using hardware contacts such as push buttons and key switches (hereinafter, referred to as a “push button type hall operating panel”) in an elevator hall (for example, Patent Literature 1). Such a hall operating panel includes car call buttons displaying floor names, and makes destination call registration when an inputting person presses the car call button.

Also, some elevator systems are provided with a touch panel type hall operating panel in an elevator hall (for example, Patent Literature 2). The basic screen of a touch panel of the hall operating panel disclosed in Patent Literature 2 includes car call buttons displaying floor names and a menu button. When an inputting person touches the car call button, the hall operating panel makes destination call registration, and when the inputting person touches the menu button, the hall operating panel changes over the screen thereof to a screen so that various special operation instructions can be given. Thus, the touch panel type hall operating panel has an advantage of being capable of being used in a wide variety of applications as compared with the push button type hail operating panel.

### CITATION LIST

### Patent Literature

Patent Literature 1: Japanese Patent Laid-Open No. 63-218484 (for example, FIG. 1)
Patent Literature 2: Japanese Patent Laid-Open No. 2006-282308 (for example, FIG. 8)

### SUMMARY OF INVENTION

### Technical Problem

Unfortunately, the conventional touch panel type hall operating panel has been expensive, and therefore it has been difficult in terms of cost to install a plurality of hall operating panel of this type in every elevator hall.

The present invention has been made to solve the above-described problem, and accordingly an object thereof is to provide an elevator system provided with a hall operating panel that is low in cost and can be used in a wide variety of applications.

### Means for Solving the Problems

An elevator system according to the present invention, which comprises an elevator; a hall operating panel which is provided in an elevator hall and has destination floor input means; and a controller for controlling the elevator based on the information inputted by the hall operating panel, is characterized by further comprising ID number input means provided on the hall operating panel; first input changeover means which is provided on the hall operating panel to accomplish changeover so as to make the destination floor input means invalid and to make the ID number input means valid; storage means for storing corresponding information comprising a plurality of ID numbers and a plurality of pieces of special operation information related to each of the ID numbers; normal operation instructing means for giving a normal operation instruction to the elevator based on the destination floor information inputted by the destination floor input means; special operation information specifying means for specifying special operation information related to the inputted ID number based on the ID number inputted by the ID number input means and the corresponding information stored in the storage means; and special operation instructing means for giving a special operation instruction to the elevator based on the special operation information specified by the special operation information specifying means.

An elevator system according to the next invention is characterized in that the elevator system further comprises special operation object input means which is provided on the hall operating panel to input elevator information or floor information based on the special operation information specified by the special operation information specifying means, and the special operation instructing means gives a special operation instruction to the elevator based on the special operation information specified by the special operation information specifying means and the elevator information or floor information inputted by the special operation object input means.

An elevator system according to the next invention is characterized in that the storage means and the special operation information specifying means are provided in the hall operating panel and the controller.

An elevator system according to the next invention is characterized in that the elevator system further comprises ID number change input means which is provided on the hall operating panel to input the pre-change ID number and a new ID number; ID number changing means for changing the ID number in the corresponding information stored in the storage means based on the pre-change ID number and the new ID number inputted by the ID number change input means; and second input changeover means which is provided on the hall operating panel to accomplish changeover so as to make the destination floor input means and the ID number input means invalid and to make the pre-change and after-change ID numbers input means valid.

A method for controlling an elevator system according to the present invention, which controls an elevator based on the information inputted by a hall operating panel provided in an elevator hall, comprises a storing step of storing corresponding information combining a plurality of ID numbers and a plurality of pieces of special operation information related to each of the ID numbers; a first changeover judging step of judging whether or not a first input changeover signal has been inputted by the hall operating panel; a destination floor judging step of judging, if it is judged in the first changeover judging step that the first input changeover signal has not been inputted, whether or not destination floor information has been inputted by the hall operating panel; a normal operation instructing step of giving a normal operation instruction to the elevator based on the inputted destination floor information if it is judged in the destination floor judging step that the destination floor information has been inputted; an ID number judging step of judging, if it is judged in the first changeover judging step that the first input changeover signal has been inputted, whether or not an ID number has been inputted by the hall operating panel; a special operation information specifying step of specifying, if it is judged in the ID number judging step that the ID number has been inputted, special operation information related to the inputted ID number based on the inputted ID number and the corresponding information stored in the storing step; and a special operation instructing step of giving a special operation instruction to the elevator based on the special operation information specified in the special operation information specifying step.

A method for controlling an elevator system according to the next invention is characterized in that the method further comprises a special operation object judging step of judging, based on the special operation information specified in the special operation information specifying step, whether or not elevator information or floor information has been inputted, and in the special operation instructing step, if it is judged in the special operation object judging step that the elevator information or floor information has been inputted, a special operation instruction is given to the elevator based on the elevator information or floor information inputted in the special operation object judging step and the special operation information specified in the special operation information specifying step.

A method for controlling an elevator system according to the next invention is characterized in that the method further comprises a second changeover judging step of judging whether or not a second input changeover signal has been inputted by the hall operating panel; an ID number change judging step of judging, if it is judged in the second changeover judging step that the second input changeover signal has been inputted, whether or not the pre-change ID number and a new ID number have been inputted by the hall operating panel; and an ID number changing step of changing the ID number in the corresponding information stored in the storing step based on the pre-change ID number and the new ID number inputted in the ID number change judging step.

### Advantageous Effects of Invention

According to the present invention, merely by adding one button to the conventional push button type hall operating panel, there can be provided an elevator system provided with a hall operating panel that can give various special operation instructions. Thereby, there can be provided an elevator system provided with a hall operating panel that is low in cost and can be used in a wide variety of applications.

### BRIEF DESCRIPTION OF THE DRAWINGS

FIG. 1 is a general configuration diagram of the elevator system in accordance with the present invention.

FIG. 2 is an appearance view of a hall operating panel 4 in accordance with the present invention.

FIG. 3 is a flowchart for the normal operation processing performed by the hall operating panel 4 and the group controller 1 in accordance with the present invention.

FIG. 4 is a flowchart showing some of special operation processing that is started by the hall operating panel 4 in accordance with the present invention after the function button 51 has been pressed.

FIG. 5 is a flowchart showing the VIP operation processing performed by the hall operating panel 4 and the group controller 1 in accordance with a first embodiment.

FIG. 6 is a flowchart showing the call-back operation processing performed by the hall operating panel 4 and the group controller 1 in accordance with the first embodiment.

FIG. 7 is a flowchart showing the service floor cut operation processing performed by the hall operating panel 4 and the group controller 1 in accordance with the first embodiment.

FIG. 8 shows a normal operation floor input screen 100.

FIG. 9 shows a normal operation floor display screen 101.

FIG. 10 shows a normal operation elevator display screen 102.

FIG. 11 shows an ID number input screen 103.

FIG. 12 shows an error screen 104.

FIG. 13 shows a VIP operation floor input screen 105.

FIG. 14 shows a VIP operation floor display screen 106.

FIG. 15 shows a VIP operation elevator display screen 107.

FIG. 16 shows a call-back operation elevator display screen 108.

FIG. 17 shows a service floor cut operation floor input screen 109.

FIG. 18 shows a service floor cut operation floor display screen 110.

FIG. 19 is a flowchart showing the ID number changing processing performed by the hall operating panel 4 and the group controller 1 in accordance with a second embodiment.

FIG. 20 is a flowchart showing the VIP operation processing performed by the hall operating panel 4 and the group controller 1 in accordance with the second embodiment.

FIG. 21 is a flowchart showing the call-back operation processing performed by the hall operating panel 4 and the group controller 1 in accordance with the second embodiment.

FIG. 22 is a flowchart showing the service floor cut operation processing performed by the hall operating panel 4 and the group controller 1 in accordance with the second embodiment.

FIG. 23 shows a pre-change ID number input screen 111.

FIG. 24 shows a new ID number input screen 112.

### DESCRIPTION OF SYMBOLS

1 group controller

3 elevator

4 hall operating panel

45 input section

50 destination floor input section

50a ten-key pad

51 function button

### Description of Embodiments

### First Embodiment

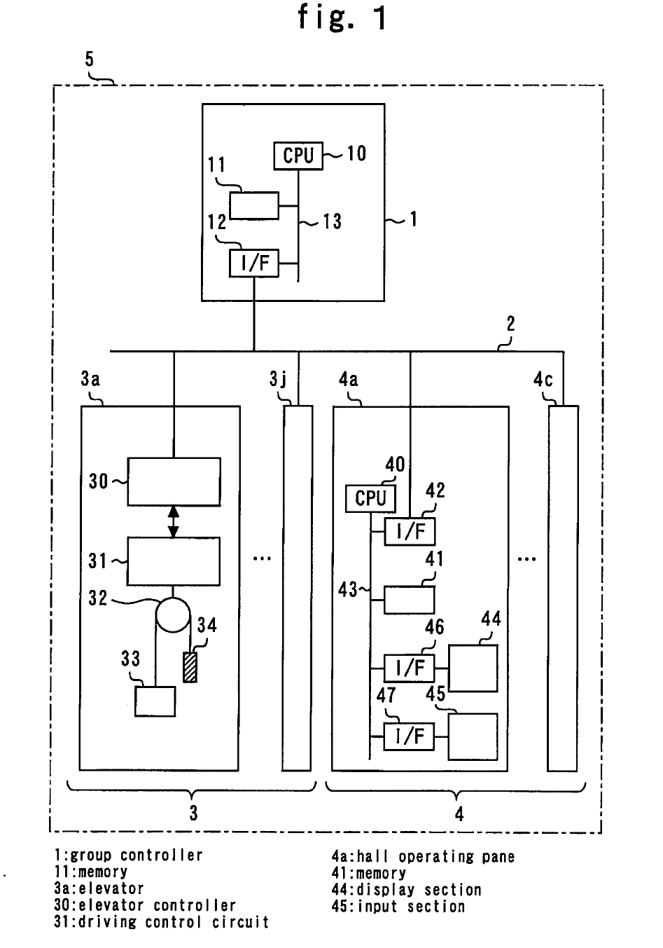

A first embodiment of the present invention will now be described with reference to FIGS. 1 to 18.

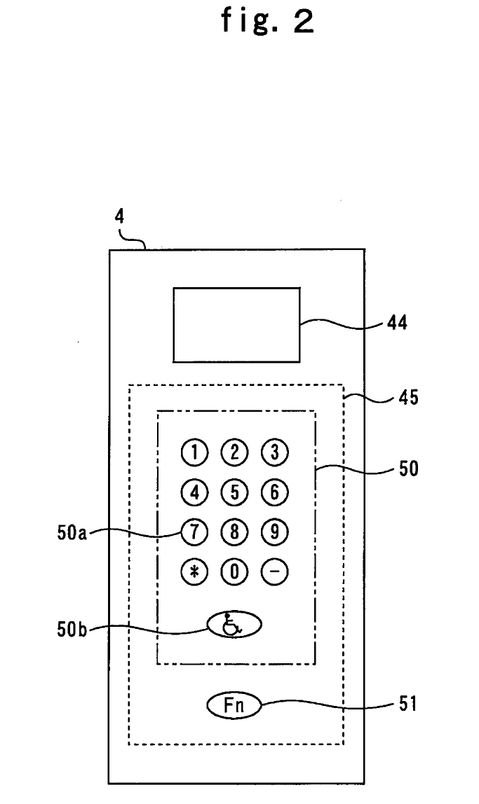

First, the configuration of an elevator system in accordance with the present invention is explained with reference to FIGS. 1 and 2. FIG. 1 is a general configuration diagram of the elevator system in accordance with the present invention. FIG. 2 is an appearance view of a hall operating panel 4 in accordance with the present invention. In a building 5, there are installed a plurality of elevators 3, one or a plurality of hall operating panels 4 provided in an elevator hall, and a group controller 1, and these elements are connected to a bus 2. Herein, the “elevator” means an elevator of one car unit. FIG. 1 shows that ten elevators 3 of 3a to 3j are provided in the building 5, and three hall operating panels 4 of 4a to 4c are provided. Also, the elevator systems as shown in FIG. 1 may be provided in plural numbers in the building 5.

Next, the configuration of the elevator 3 is explained. An elevator car 33 and a weight 34 are moved up and down by a traction machine 32, and the traction machine 32 is drivingly controlled by a driving control circuit 31. An elevator controller 30 is connected to the bus 2, and controls the driving control circuit 31 based on a control instruction received from the group controller 1 via the bus 2. The elevator controller 30 and the driving control circuit 31 are housed in a control panel (not shown) of the elevator 3.

Next, the configuration of the group controller 1 is explained. The group controller 1 is provided, for example, in a control panel in a building caretaker's room, and carries out group control of the elevators 3a to 3j based on the information received from the hall operating panels 4a to 4c. The group controller 1 has a memory 11 for storing programs and various pieces of information and a CPU 10 that is a central processing unit for executing the programs stored in the memory 11, and these elements are connected to a bus 13. Also, the bus 13 is connected to the bus 2 via an J/F 12.

Next, the configuration of the hall operating panel 4 is explained. The hall operating panel 4 is provided in elevator halls of all or some floors. Also, the hall operating panel 4 can be provided in a number of one or in plural numbers on one floor. The hall operating panel 4 has a memory 41 for storing programs and various pieces of information and a CPU 40 that is a central processing unit for executing the programs stored in the memory 41, and these elements are connected to a bus 43. The memory 41 of each of the hall operating panels 4a to 4c also stores a floor on which an inputting person of the hall operating panels 4a to 4c is present (hereinafter, referred to as an “input floor”), that is, information for specifying a floor on which the hall operating panels 4a to 4c are provided (hereinafter, referred to as “input floor information”). Also, the bus 43 is connected to the bus 2 via an I/F 42.

Further, the hall operating panel 4 has a display section 44 such as a liquid crystal screen and an input section 45 consisting of a plurality of push buttons and key switches, and these sections are connected to the bus 43 via an I/F 46 and an I/F 47, respectively. As shown in FIG. 2, the input section 45 has a destination floor input section 50 for a general passenger to input his/her destination floor and a function button 51 that is pressed when a specific passenger such as a VIP, maintenance personnel and cleaning personnel for the elevator, enters his/her ID number. The destination floor input section 50 has a ten-key pad 50a and a button 50b for disabled persons. The ten-key pad 50a consists of a total of ten numeral buttons indicating numerals of “0” to “9”, a “*” button representing a special floor such as an entrance floor, and a “−” button (minus button) representing basement. The button 50b for disabled persons does not have to be provided. Besides, English letter buttons indicating English letters may be provided. The function button 51 has not been provided on the conventional push button type hall operating panel.

In the memory 11 of the group controller 1 and the memory 41 of the hall operating panel 4, corresponding information as shown in Table 1 below is stored in advance at the time of shipment. This corresponding information is such that a plurality of ID numbers and a plurality of pieces of special operation information corresponding to the ID numbers are related to each other.

TABLE 1

| ID number | Special operation information |
|---|---|
| 1111 | VIP operation |
| 1112 | Call-back operation No. 1 elevator |
| 1113 | Call-back operation No. 2 elevator |

.
.
.

| | |
|---|---|
| 1121 | Call-back operation No. 10 elevator |
| 1122 | Service floor cut operation |

The ID number in the corresponding information in Table 1 consists of a four-digit numeral. The four-digit ID number has an advantage of generally having familiarity. However, an ID number of other digits may also be used. The special operation means an elevator operation having various functions other than the normal operation, for example, including “VIP operation”, “call-back operation”, and “service floor cut operation” given in Table 1. The “VIP operation” is a special operation for operating a car to a destination floor preferentially, and is used by specific passengers such as VIPs. The “call-back operation” is a special operation for calling a car to a prescribed floor, and is used by the maintenance personnel and cleaning personnel for the elevator. Also, the “service floor cut operation” is a special operation in which a designated floor is cut off from the service objects so that the car does not stop at the designated floor. In Table 1, for the VIP operation and the service floor cut operation, the special operation information consists of the name of special operation only. On the other hand, for the call-back operation, the special operation information consists of the name of special operation and the name of elevator. The “No. 1 elevator” to “No. 10 elevator” represent the names of the elevators 3a to 3j.

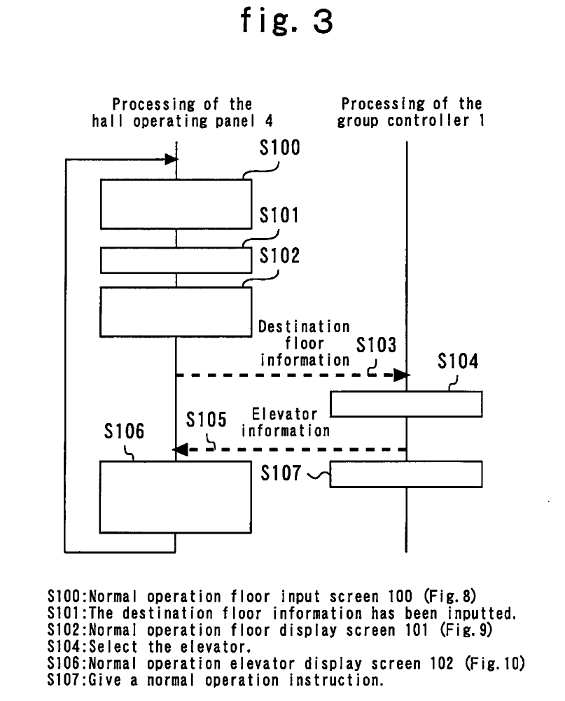

Next, the operation of the elevator system in accordance with the first embodiment is explained with reference to FIGS. 3 to 18. The hall operating panel 4 performs the processing of normal operation until the function button 51 is pressed, and starts the processing of a special operation when the function button 51 is pressed. Also, the group controller 1 performs the processing of normal operation until receiving an ID number from the hall operating panel 4, and starts the processing of a special operation when receiving the ID number.

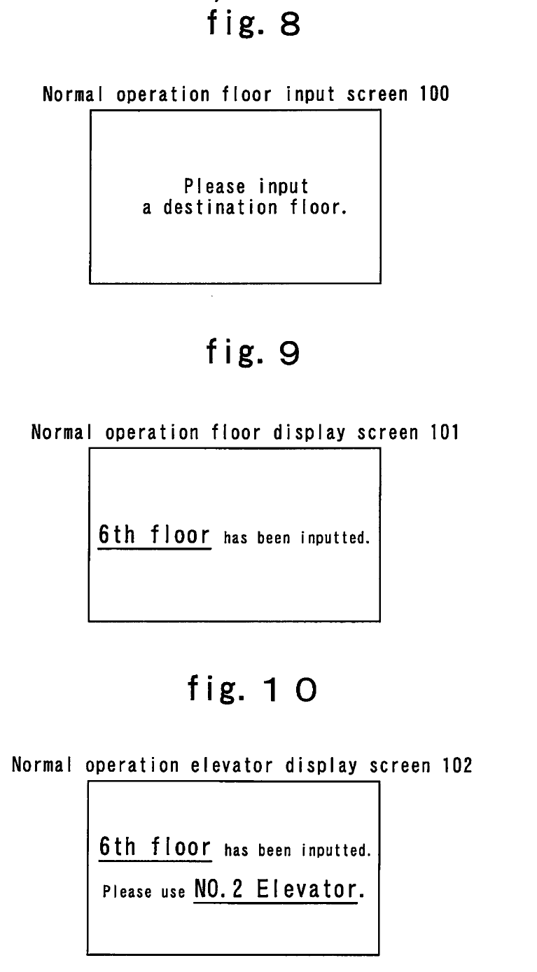

First, the processing of normal operation that is performed by the hall operating panel 4 and the group controller 1 is explained with reference to FIG. 3 and FIGS. 8 to 10. FIG. 3 is a flowchart for the normal operation processing performed by the hall operating panel 4 and the group controller 1 in accordance with the present invention. First, the CPU 40 of the hall operating panel 4 causes a display section 44 to display a normal operation floor input screen 100 shown in FIG. 8, and waits the input of destination floor information (S100). On this normal operation floor input screen 100, for example, a message for prompting the user to input destination floor information is displayed. This destination floor information is a numeral or an English letter that specifies the destination floor desired by the general passenger, and is inputted by the operation of the destination floor input section 50.

For example, when a person who inputs a destination floor wants to go to the 3rd floor, the inputting person presses the “3” button of the ten-key pad 50a. When the inputting person wants to go to the 3rd basement, he/she presses the “−” button of the ten-key key pad 50a, and successively presses the “3” button. When the inputting person wants to go to the special floor, he/she presses the “*” button of the ten-key pad 50a. Also, when the button 50b for disabled persons is pressed before the ten-key pad 50a is operated, the operation of the ten-key pad 50a can be performed by taking time longer than usual.

When the destination floor information is inputted (S101), the CPU 40 next causes the display section 44 to display a normal operation floor display screen 101 shown in FIG. 9, and displays the inputted destination floor information (S102). Also, the CPU 40 sends this destination floor information to the group controller 1 (S103). Next, when receiving this destination floor information from the hall operating panel 4, the CPU 10 of the group controller 1 selects the elevator 3 to be subjected to normal operation to that destination floor (S104). At this time, the CPU 10 selects one appropriate elevator 3, for example, by referring to the operating conditions of the elevators 3a to 3j. Next, the CPU 10 sends the elevator information of the selected elevator 3 to the hall operating panel 4 (S105). This elevator information is a numeral or an English letter specifying the elevator. Next, when receiving this elevator information from the group controller 1, the CPU 40 of the hall operating panel 4 causes the display section 44 to display a normal operation elevator display screen 102 shown in FIG. 10 (S106). On this normal operation elevator display screen 102, this elevator information is displayed. Thereby, the person who inputted destination floor can know which elevator is operated to the destination floor by normal operation. Thereafter, the CPU returns to S100, and causes the display section 44 to display the normal operation floor input screen 100 shown in FIG. 8.

On the other hand, the CPU 10 of the group controller 1 gives a normal operation instruction to the elevator controller 30 of the elevator 3 selected in S104 (S107). Then, the elevator controller 30 of the elevator 3 receiving this normal operation instruction once operates the car 33 to the input floor, and operates the car 33 to the destination floor after the passenger has gotten in the car 33.

Next, the processing for special operation performed by the hall operating panel 4 and the group controller 1 is explained with reference to FIGS. 4 to 7 and FIGS. 11 to 18. When the function button 51 is pressed during the time when the display section 44 displays the normal operation floor input screen 100 shown in FIG. 8, the hall operating panel 4 starts special operation processing. FIG. 4 is a flowchart showing some of special operation processing that is started by the hall operating panel 4 in accordance with the present invention after the function button 51 has been pressed.

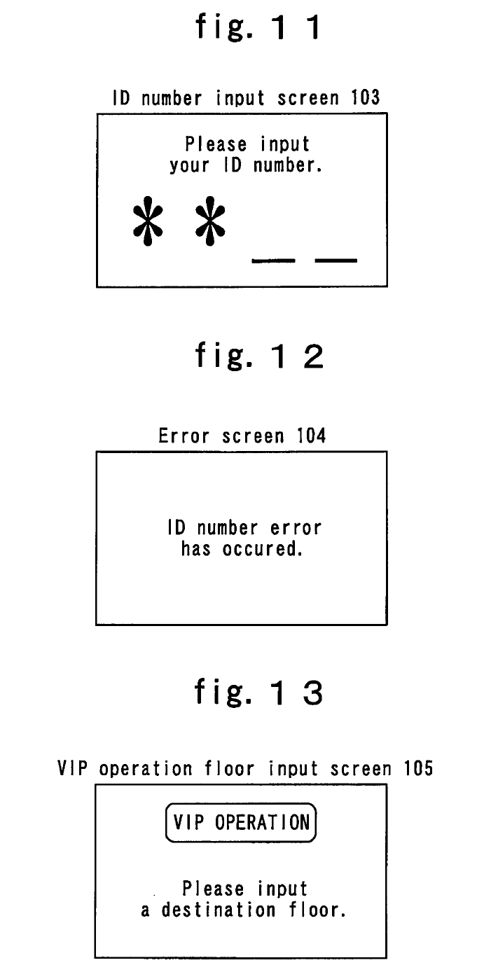

First, the CPU 40 of the hall operating panel 4 causes the display section 44 to display an ID number input screen 103 shown in FIG. 11 (S200). On this ID number input screen 103, for example, a message for prompting the user to input his/her ID number and the input field of ID number are displayed. The ID number is inputted by the operation of the ten-key pad 50a. Then, in the input field of the ID number input screen 103, the same number of “*” marks as the number of inputted numerals are displayed. Thereby, the ID number can be prevented from being seen by a person other than the inputting person, and also the inputting person can know what number of numerals has been inputted. In place of the “*” marks, other letters or marks may be displayed.

Next, the CPU 40 judges whether or not the four-digit ID number has been inputted (S201). If the ID number has not been inputted, the CPU 40 next judges whether or not predetermined time has elapsed after the function button 51 was pressed (S202). If the predetermined time has not elapsed, the CPU returns to S201. If the predetermined time has elapsed, the CPU 40 next causes the display section 44 to display an error screen 104 shown in FIG. 12 (S203). On this error screen 104, for example, a message that the inputted ID number is invalid is displayed. Thereafter, the CPU 40 causes the display section 44 to display the normal operation floor input screen 100 shown in FIG. 8, and starts the normal operation processing shown in FIG. 3.

If the four-digit ID number has been inputted in S201, the CPU 40 next collates the inputted ID number with a plurality of ID numbers stored in advance in the memory 41 (S204), and judges whether or not an ID number coinciding with the inputted ID number is present (S205). If the coinciding ID number is absent, the CPU proceeds to S203, where the CPU 40 causes the display section 44 to display the error screen 104 shown in FIG. 12. On the other hand, if the coinciding ID number is present, the CPU 40 next specifies special operation information related to this ID number by referring to the corresponding information given in Table 1 stored in the memory 41 (S206).

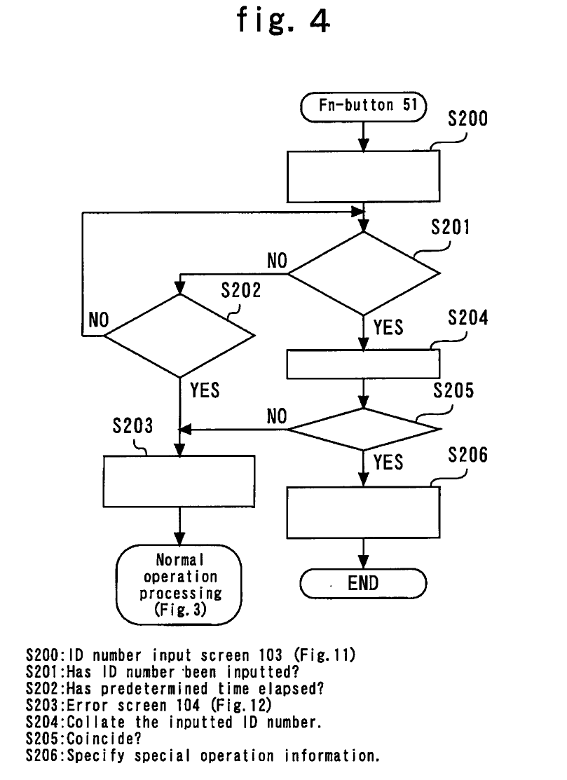

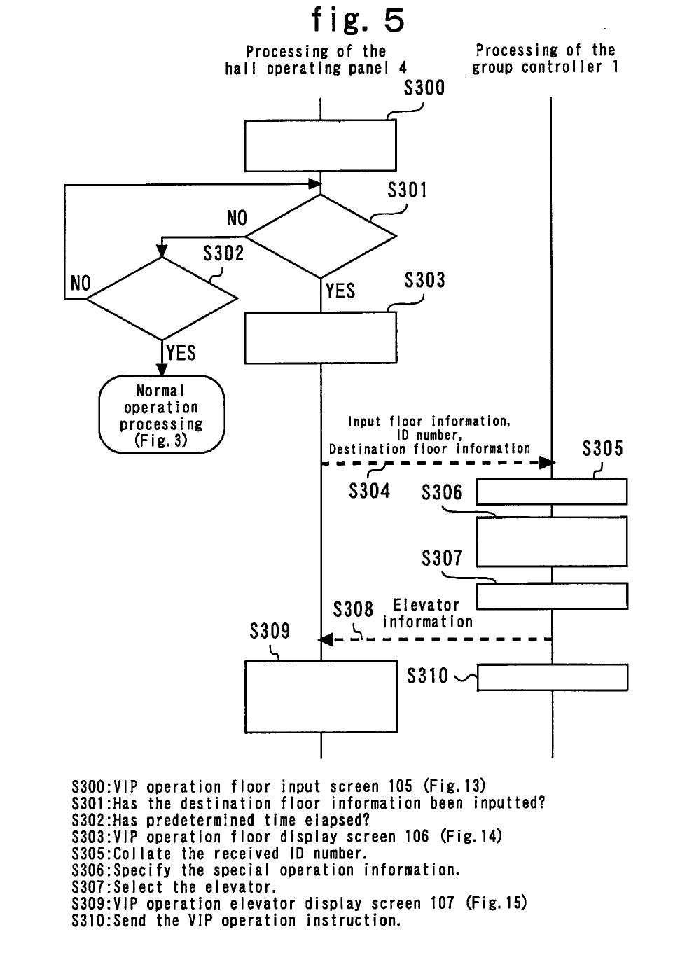

Next, when the CPU 40 of the hall operating panel 4 specifies the “VIP operation” as the special operation information in S206 in FIG. 4, subsequently, the hall operating panel 4 and the group controller 1 start VIP operation processing shown in FIG. 5. FIG. 5 is a flowchart showing the VIP operation processing performed by the hall operating panel 4 and the group controller 1 in accordance with the first embodiment. First, the CPU 40 of the hall operating panel 4 causes the display section 44 to display a VIP operation floor input screen 105 shown in FIG. 13 (S300). On this VIP operation floor input screen 105, for example, a description of the start of “VIP operation” processing and a message for prompting the user to input destination floor information are displayed. This destination floor information is a numeral or English letter for specifying a destination floor desired by the person who inputted the ID number, and is inputted by the operation of the ten-key pad 50a. Next, the CPU 40 judges whether or not the destination floor information has been inputted (S301). If the destination floor information has not been inputted, the CPU 40 next judges whether or not predetermined time has elapsed after the ID number was inputted in S201 in FIG. 4 (S302). If the predetermined time has not elapsed, the CPU returns to S301. On the other hand, if the predetermined time has elapsed, the CPU 40 next causes the display section 44 to display the normal operation floor input screen 100 shown in FIG. 8, and starts the normal operation processing shown in FIG. 3.

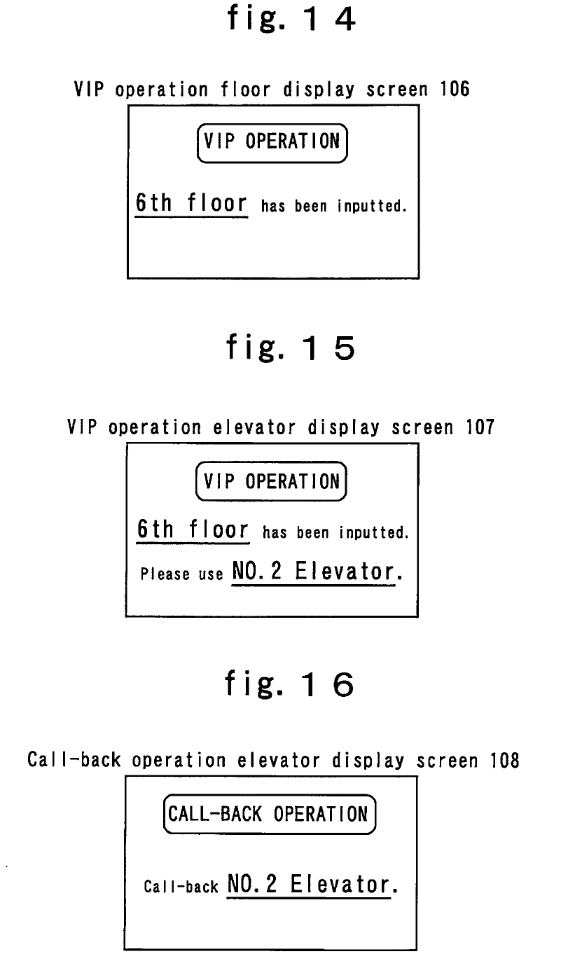

If the destination floor information has been inputted in S301, the CPU 40 next causes the display section 44 to display a VIP operation floor display screen 106 shown in FIG. 14 (S303). On this VIP operation floor display screen 106, the destination floor information inputted in S301 is displayed. Also, the CPU 40 sends the input floor information stored in advance in the memory 41, the ID number inputted in S201 in FIG. 4, and the destination floor information inputted in S301 to the group controller 1 (S304). As described above, this input floor information is information that specifies the floor on which the hall operating panel 4 is provided, that is, the input floor on which the person who inputted the ID number is present. Next, when receiving the input floor information, ID number, and destination floor information from the hall operating panel 4, the CPU 10 of the group controller 1 collates the received ID number with a plurality of ID numbers stored in advance in the memory 11 (S305), and specifies an ID number coinciding with this ID number. Next, the CPU 10 specifies the “VIP operation” as the special operation information related to this ID number by referring to the corresponding information given in Table 1 stored in the memory 11 (S306).

Next, the CPU 10 selects the elevator 3 to be subjected to the VIP operation (S307). At this time, the CPU 10 selects one elevator 3 of the least call registration, for example, by referring to the operating conditions of the elevators 3a to 3j. Next, the CPU 10 sends the elevator information of the selected elevator 3 to the hall operating panel 4 (S308). Next, when receiving this elevator information from the group controller 1, the CPU 40 of the hall operating panel 4 causes the display section 44 to display a VIP operation elevator display screen 107 shown in FIG. 15 (S309). On this VIP operation elevator display screen 107, this elevator information is displayed. Thereby, the person who inputted the ID number can know which elevator is operated to the destination floor by the VIP operation. On the other hand, the CPU 10 of the group controller 1 sends a VIP operation instruction to the elevator controller 30 of the elevator 3 selected in S307 (S310). Then, the elevator controller 30 of the elevator 3 that receives this VIP operation instruction once operates the car 33 to the input floor, and operates the car 33 to the destination floor preferentially after the passenger has gotten in the car 33.

On the other hand, when the CPU 40 of the hall operating panel 4 specifies the “call-back operation No.2 elevator” as the special operation information in S206 in FIG. 4, subsequently, the hall operating panel 4 and the group controller 1 start call-back operation processing shown in FIG. 6. FIG. 6 is a flowchart showing the call-back operation processing performed by the hall operating panel 4 and the group controller 1 in accordance with the first embodiment. First, the CPU 40 of the hall operating panel 4 causes the display section 44 to display a call-back operation elevator display screen 108 shown in FIG. 16 (S400). On this call-back operation elevator display screen 108, for example, a description of the start of “call-back operation” processing and the elevator information of the elevator to be subjected to call-back operation are displayed. This elevator information is specified from the special operation information. Thereby, the person who inputted the ID number can know which elevator is subjected to call-back operation. Also, the CPU 40 sends the ID number inputted in S201 in FIG. 4 to the group controller 1 (S401). Next, when receiving this ID number from the hall operating panel 4, the CPU 10 of the group controller 1 collates the received ID number with the plurality of ID numbers stored in advance in the memory 11 (S402), and specifies an ID number coinciding with this ID number. Next, the CPU 10 specifies the “call-back operation No.2 elevator” as the special operation information related to this ID number by referring to the corresponding information given in Table 1 stored in the memory 11 (S403).

Next, the CPU 10 sends a call-back operation instruction to the elevator controller 30 of the elevator 3 specified from the special operation information in S403 (S404). Then, the elevator controller 30 of the elevator 3 that has received this call-back operation instruction operates the car 33 to the prescribed floor.

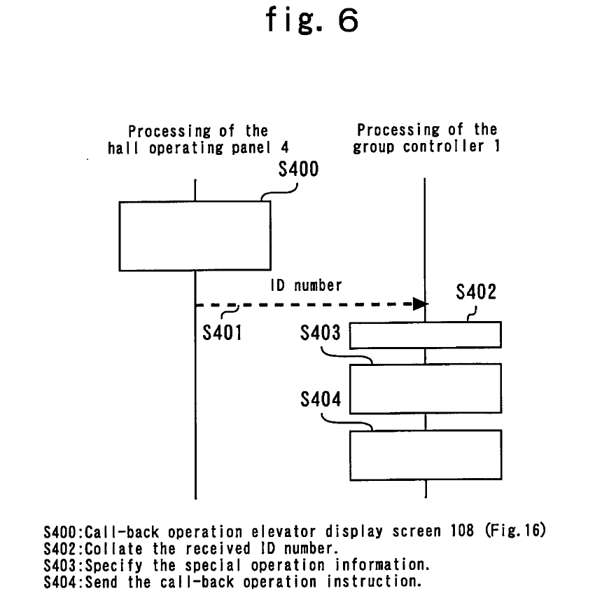

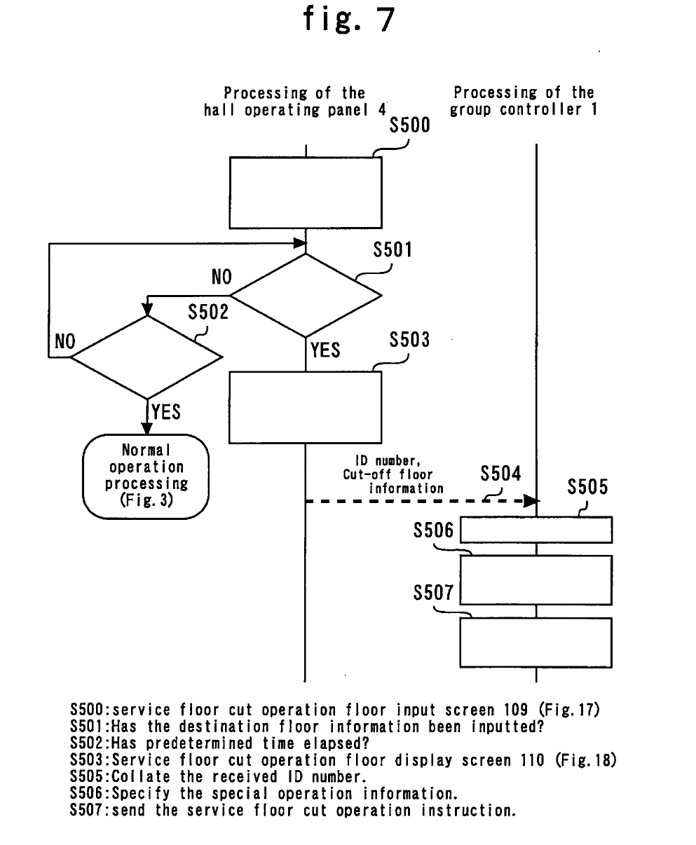

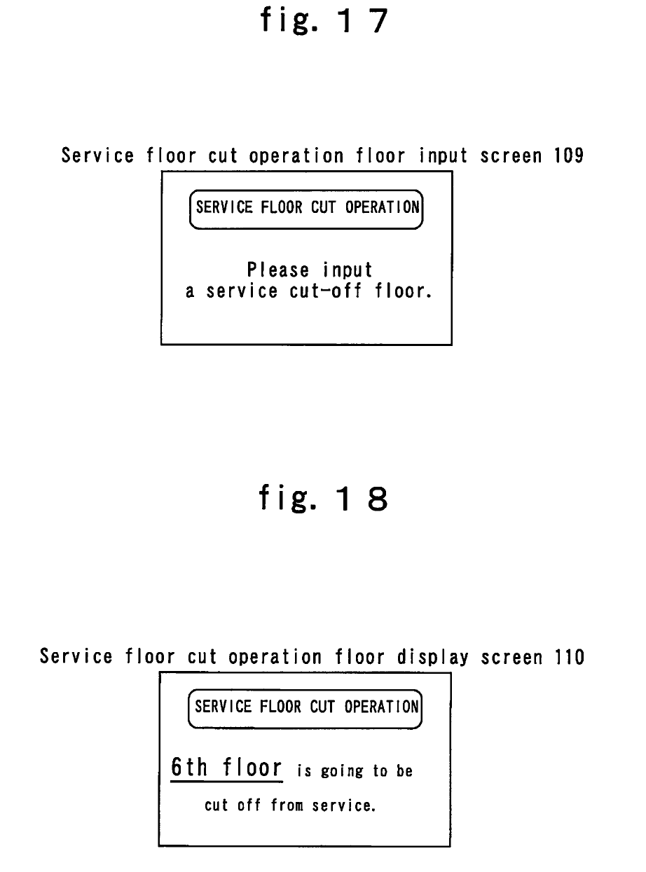

On the other hand, when the CPU 40 of the hall operating panel 4 specifies the “service floor cut operation” as the special operation information in S206 in FIG. 4, subsequently, the hall operating panel 4 and the group controller 1 start service floor cut operation processing shown in FIG. 7. FIG. 7 is a flowchart showing the service floor cut operation processing performed by the hall operating panel 4 and the group controller 1 in accordance with the first embodiment. First, the CPU 40 of the hall operating panel 4 causes the display section 44 to display a service floor cut operation floor input screen 109 shown in FIG. 17 (S500). On this service floor cut operation floor input screen 109, for example, a description of the start of “service floor cut operation” processing and a message for prompting the user to input cut-off floor information are displayed. This cut-off floor information is a numeral or English letter for specifying a floor that is desired to be cut off from the service objects by the person who inputted the ID number (“cut-off floor”), and is inputted by the operation of the ten-key pad 50a. Next, the CPU 40 judges whether or not the cut-off floor information has been inputted (S501). If the cut-off floor information has not been inputted, the CPU 40 next judges whether or not predetermined time has elapsed after the ID number was inputted in S201 in FIG. 4 (S502). If the predetermined time has not elapsed, the CPU returns to S501. On the other hand, if the predetermined time has elapsed, the CPU 40 next causes the display section 44 to display the normal operation floor input screen 100 shown in FIG. 8, and starts the normal operation processing shown in FIG. 3.

If the cut-off floor information has been inputted in S501, the CPU 40 next causes the display section 44 to display a service floor cut operation floor display screen 110 shown in FIG. 18 (S503). On this service floor cut operation floor display screen 110, the cut-off floor information is displayed. Also, the CPU 40 sends the ID number inputted in S201 in FIG. 4 and the cut-off floor information inputted in S501 to the group controller 1 (S504). When receiving this ID number and the cut-off floor information from the hall operating panel 4, the CPU 10 of the group controller 1 collates the received ID number with the plurality of ID numbers stored in advance in the memory 11 (S505), and specifies an ID number coinciding with this ID number. Next, the CPU 10 specifies the “service floor cut operation ” as the special operation information related to this ID number by referring to the corresponding information given in Table 1 stored in the memory 11 (S506).

Next, the CPU 10 sends a service floor cut operation instruction to the elevator controller 30 of the prescribed elevator 3 (S507). Then, the elevator controller 30 of the elevator 3 that has received this service floor cut operation instruction cuts off the cut-off floor from the service objects.

After the special operation processing shown in FIGS. 4 to 7 has been finished, the hall operating panel 4 and the group controller 1 start the normal operation processing shown in FIG. 3.

The function button 51 corresponds to a first input changeover means.

In this embodiment, in the corresponding information given in Table 1, for the call-back operation, the special operation information consists of the name of special operation and the name of elevator. However, the special operation information may consist of only the name of special operation. In this case, by causing the person who inputted the ID number to input the elevator information, the elevator to be subjected to call-back operation is specified.

According to this embodiment, an elevator system provided with a hall operating panel that is low in cost and capable of giving various special operation instructions can be provided merely by adding one button to the conventional push button type hall operating panel using hardware contacts such as push buttons and key switches.

### Second Embodiment

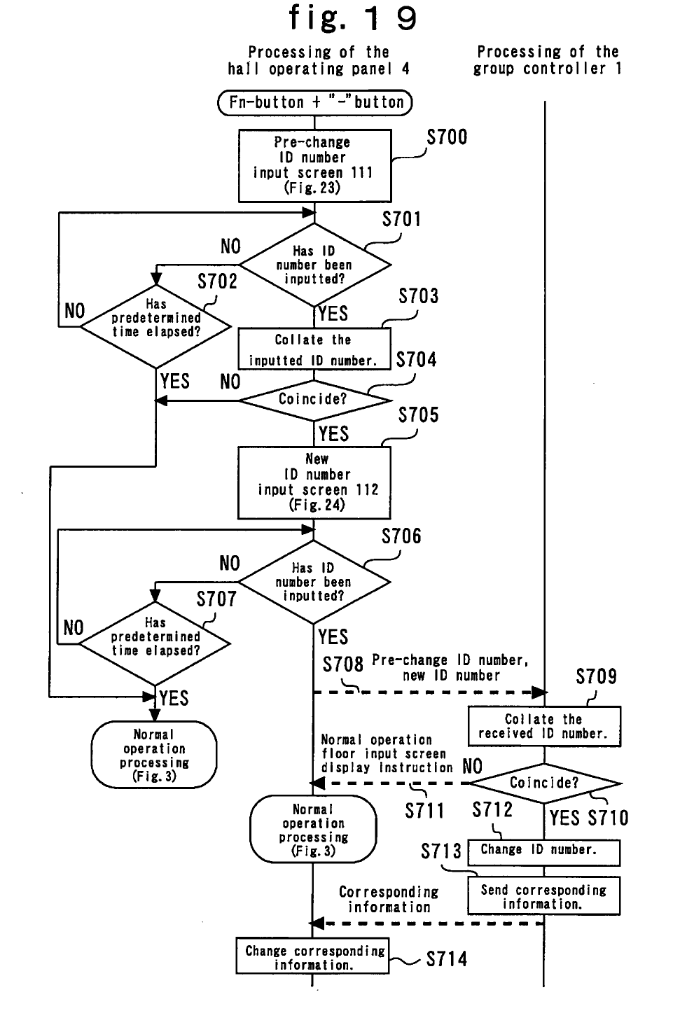

A second embodiment of the present invention will now be described with reference to FIGS. 19 to 24.

First, the configuration of an elevator system in accordance with the second embodiment is the same as that having been explained with reference to FIGS. 1 and 2 in the first embodiment.

Next, the operation of the elevator system in accordance with the second embodiment is explained. The hall operating panel in accordance with the second embodiment can perform processing for changing the ID number in addition to the normal operation processing and the special operation processing of the first embodiment. The processing for changing the ID number is started when the minus button (“−” button) of the ten-key pad 50a is pressed after the function button 51 has been pressed.

On the other hand, until receiving an ID number from the hall operating panel 4, the group controller 1 performs the normal operation, and, when receiving the ID number, starts the special operation processing. Further, when receiving the pre-change ID number and a new ID number from the hall operating panel 4, the group controller 1 starts the processing for changing the ID number. The normal operation processing in accordance with the second embodiment is the same as that having been explained with reference to FIG. 3 and FIGS. 8 to 10 in the first embodiment.

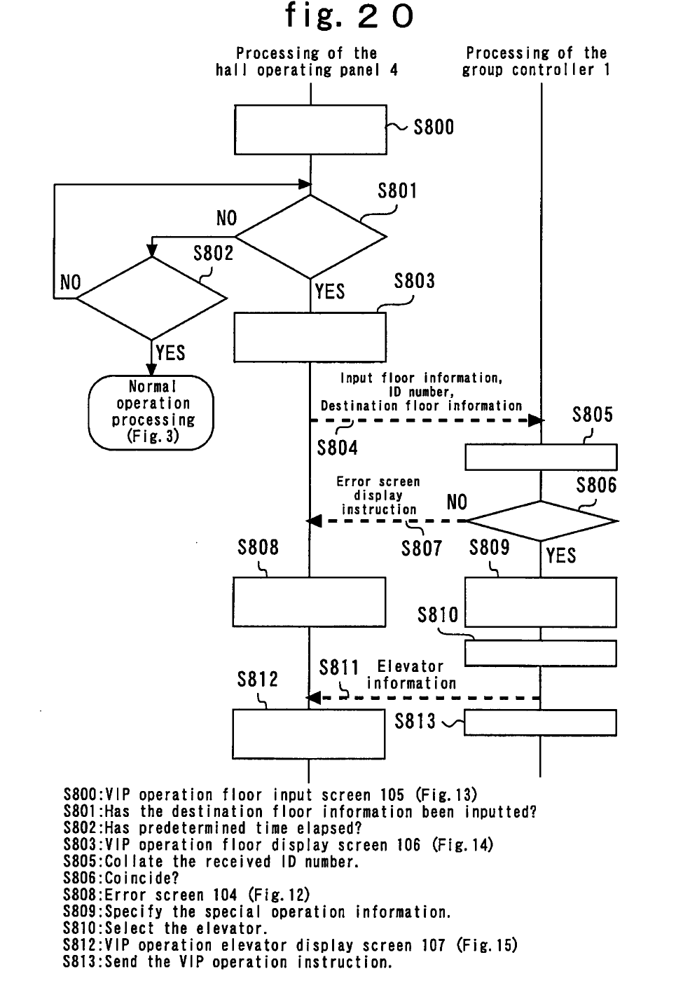

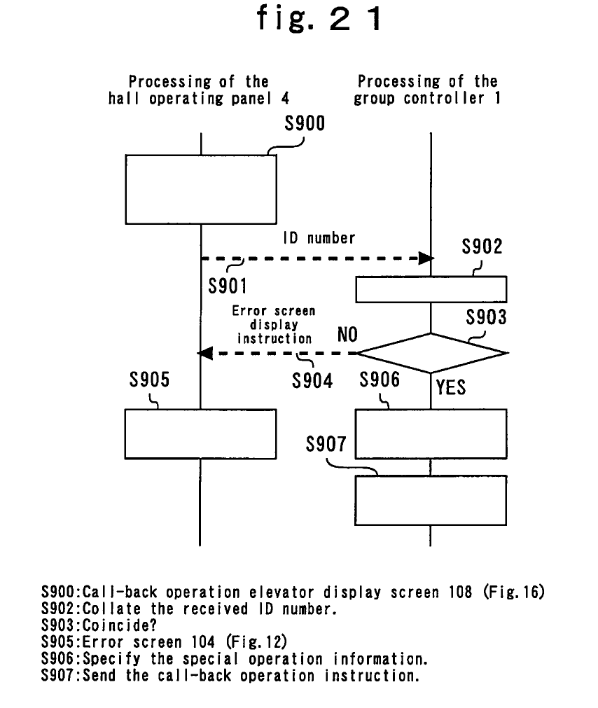

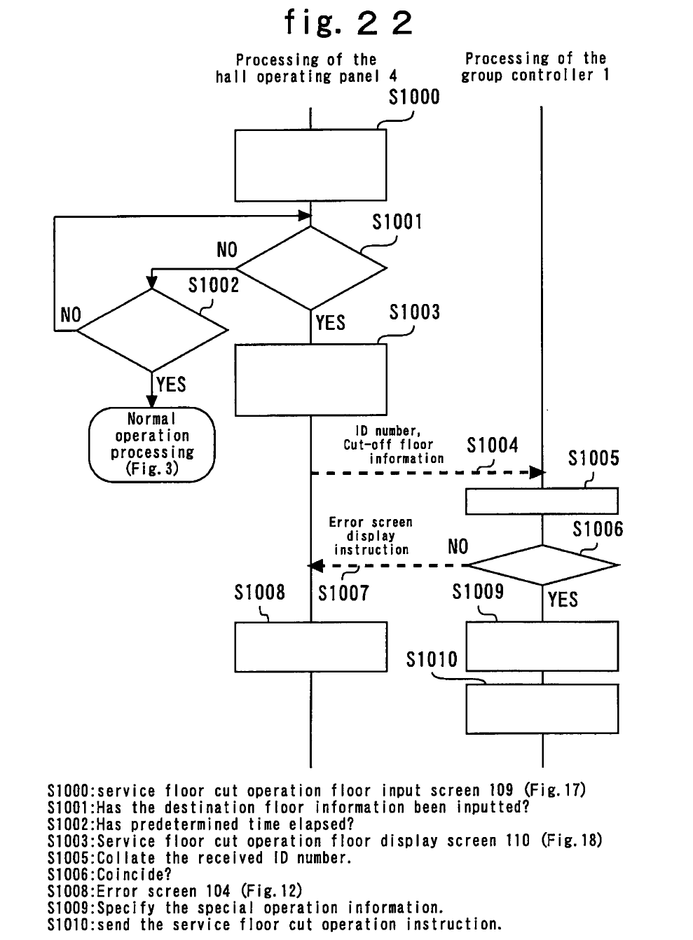

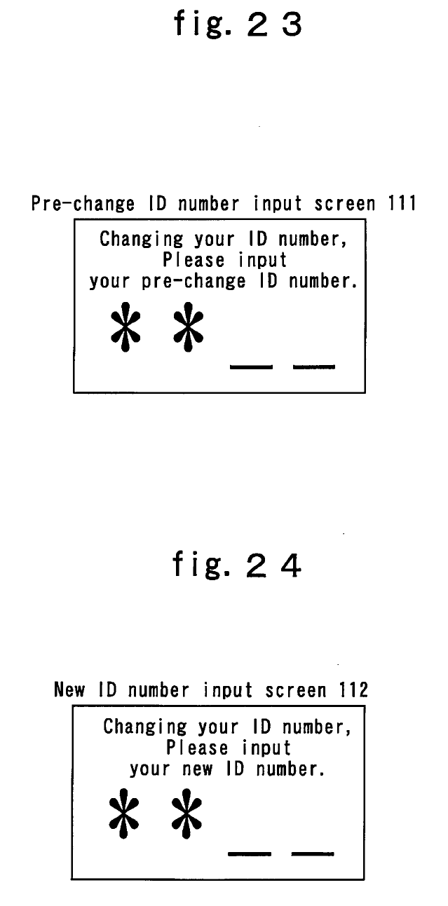

First, the processing for changing the ID number performed by the hall operating panel 4 and the group controller 1 is explained with reference to FIGS. 19, 23 and 24. When the function button 51 is pressed during the time when the normal operation floor input screen 100 shown in FIG. 8 is being displayed in the display section 44, and the minus button is next pressed, the hall operating panel 4 starts the processing for changing the ID number. FIG. 19 is a flowchart showing the ID number changing processing performed by the hall operating panel 4 and the group controller 1 in accordance with the second embodiment. First, the CPU 40 of the hall operating panel 4 causes the display section 44 to display a pre-change ID number input screen 111 shown in FIG. 23 (S700). On this pre-change ID number input screen 111, for example, a message for prompting the user to input the pre-change ID number and the input field of ID number are displayed. Then, in the input field of the pre-change ID number input screen 111, the same number of “*” marks as the number of inputted numerals are displayed. Thereby, the ID number can be prevented from being seen by a person other than the inputting person, and also the inputting person can know what number of numerals has been inputted. In place of the “*” marks, other letters or marks may be displayed.

Next, the CPU 40 judges whether or not the four-digit ID number has been inputted (S701). If the ID number has not been inputted, the CPU 40 judges whether or not predetermined time has elapsed after the function button 51 was pressed and thereafter the minus button was pressed (S702). If the predetermined time has not elapsed, the CPU returns to S701. On the other hand, if the predetermined time has elapsed, the CPU 40 next causes the display section 44 to display the normal operation floor input screen 100 shown in FIG. 8, and starts the normal operation processing shown in FIG. 3.

If the ID number has been inputted in S701, the CPU 40 next collates the inputted ID number with the plurality of ID numbers stored in advance in the memory 41 (S703), and judges whether or not an ID number coinciding with the inputted ID number is present (S704). If the ID number coinciding with the inputted ID number is absent, the CPU 40 causes the display section 44 to display the normal operation floor input screen 100 shown in FIG. 8, and starts the normal operation processing shown in FIG. 3. On the other hand, if the coinciding ID number is present, the CPU 40 next causes the display section 44 to display a new ID number input screen 112 shown in FIG. 24 (S705). On this new ID number input screen 112, for example, a message for prompting the user to input a new ID number and the input field of ID number are displayed.

Next, the CPU 40 judges whether or not the four-digit ID number has been inputted (S706). If the ID number has not been inputted, the CPU 40 next judges whether or not predetermined time has elapsed after the pre-change ID number was inputted in S701 (S707). If the predetermined time has not elapsed, the CPU returns to S707. On the other hand, if the predetermined time has elapsed, the CPU 40 causes the display section 44 to display the normal operation floor input screen 100 shown in FIG. 8, and starts the normal operation processing shown in FIG. 3.

On the other hand, if the ID number has been inputted in S706, the CPU 40 next sends the pre-change ID number inputted in S701 and the new ID number inputted in S706 to the group controller 1 (S708). Next, when receiving the pre-change ID number and the new ID number from the hall operating panel 4, the CPU 10 of the group controller 1 collates the received pre-change ID number with the plurality of ID numbers stored in advance in the memory 11 (S709), and judges whether or not an ID number coinciding with the this pre-change ID number is present (S710). If the coinciding ID number is absent, the CPU 10 next sends a normal operation floor input screen display instruction to the hall operating panel 4 (S711). When the hall operating panel 4 receives this normal operation floor input screen display instruction from the group controller 1, the CPU 40 of the hall operating panel 4 next causes the display section 44 to display the normal operation floor input screen 100 shown in FIG. 8, and starts the normal operation processing shown in FIG. 3. On the other hand, if the coinciding ID number is present, the CPU 10 of the group controller 1 next changes the pre-change ID number in the corresponding information given in Table 1 stored in the memory 11 to the new ID number (S712).

Next, the CPU 10 sends the changed corresponding information to all of the hall operating panels 4a to 4c (S713). When receiving the changed corresponding information from the group controller 1, each of the hall operating panels 4a to 4c changes the pre-change corresponding information stored in the memory 41 to the changed corresponding information (S714). The CPU 10 may perform the operation in S713 each time the ID number is changed in S712, or may perform this operation periodically regardless of the presence of the operation in S712.

Next, the processing for special operation in accordance with the second embodiment is explained with reference to FIGS. 20 to 22. The processing performed from when the hall operating panel 4 starts the special operation processing to when it specifies the special operation information is the same as the processing having been explained with reference to FIG. 4 in the first embodiment.

Next, when the CPU 40 of the hall operating panel 4 specifies the “VIP operation” as the special operation information in S206 in FIG. 4, subsequently, the hall operating panel 4 and the group controller 1 start VIP operation processing shown in FIG. 20. FIG. 20 is a flowchart showing the VIP operation processing performed by the hall operating panel 4 and the group controller 1 in accordance with the second embodiment. First, the CPU 40 of the hall operating panel 4 causes the display section 44 to display the VIP operation floor input screen 105 shown in FIG. 13 (S800). Next, the CPU 40 judges whether or not the destination floor information has been inputted (S801). If the destination floor information has not been inputted, the CPU 40 next judges whether or not the predetermined time has elapsed after the ID number was inputted in S201 in FIG. 4 (S802). If the predetermined time has not elapsed, the CPU returns to S801. On the other hand, if the predetermined time has elapsed, the CPU 40 next causes the display section 44 to display the normal operation floor input screen 100 shown in FIG. 8, and starts the normal operation processing shown in FIG. 3.

If the destination floor information has been inputted in S801, the CPU 40 next causes the display section 44 to display the VIP operation floor display screen 106 shown in FIG. 14 (S803). Also, the CPU 40 sends the input floor information stored in advance in the memory 41, the ID number inputted in S201 in FIG. 4, and the destination floor information inputted in S801 to the group controller 1 (S804). Next, when receiving the input floor information, ID number, and destination floor information from the hall operating panel 4, the CPU 10 of the group controller 1 collates the received ID number with the plurality of ID numbers stored in advance in the memory 11 (S805), and judges whether or not an ID number corresponding to this ID number is present (S806). Herein, a time lag is present between the time when the corresponding information stored in the memory 11 of the group controller 1 is changed in S713 in FIG. 19 and the time when the corresponding information stored in the memory 41 of the hall operating panel 4 is changed in S714, so that the corresponding information stored in the memory 11 and the corresponding information stored in the memory 41 are different from each other in some cases. Therefore, the collation of ID numbers is accomplished not only by the hall operating panel 4 but also by the group controller 1.

If the coinciding ID number is absent in S806, the CPU 10 next sends an error screen display instruction to the hall operating panel 4 (S807). When the hall operating panel 4 receives this error screen display instruction from the group controller 1, the CPU 40 of the hall operating panel 4 next causes the display section 44 to display the error screen 104 shown in FIG. 12 (S808). On the other hand, if the coinciding ID number is present in S807, the CPU 10 next specifies the “VIP operation” as the special operation information related to this ID number by referring to the corresponding information given in Table 1 stored in the memory 11 (S809).

Next, the CPU 10 selects the elevator 3 to be subjected to the VIP operation (S810). At this time, the CPU 10 selects one elevator 3 that is appropriate for being subjected to the VIP operation, for example, by referring to the operating conditions of the elevators 3a to 3j. Next, the CPU 10 sends the elevator information of the selected elevator 3 to the hall operating panel 4 (S811). Next, when receiving this elevator information from the group controller 1, the CPU 40 of the hall operating panel 4 causes the display section 44 to display the VIP operation elevator display screen 107 shown in FIG. 15 (S812). On the other hand, the CPU 10 of the group controller 1 sends the VIP operation instruction to the elevator controller 30 of the elevator 3 selected in S810 (S813). Then, the elevator controller 30 of the elevator 3 that receives this VIP operation instruction once operates the car 33 to the input floor, and operates the car 33 to the destination floor preferentially after the passenger has gotten in the car 33.

On the other hand, when the CPU 40 of the hall operating panel 4 specifies the “call-back operation No. 2 elevator” as the special operation information in S206 in FIG. 4, subsequently, the hall operating panel 4 and the group controller 1 start call-back operation processing shown in FIG. 21. FIG. 21 is a flowchart showing the call-back operation processing performed by the hall operating panel 4 and the group controller 1 in accordance with the second embodiment. First, the CPU 40 of the hall operating panel 4 causes the display section 44 to display the call-back operation elevator display screen 108 shown in FIG. 16 (S900). Also, the CPU 40 sends the ID number inputted in S201 in FIG. 4 to the group controller 1 (S901). Next, when receiving this ID number from the hall operating panel 4, the CPU 10 of the group controller 1 collates the received ID number with the plurality of ID numbers stored in advance in the memory 11 (S902), and judges whether or not an ID number coinciding with the received ID number is present (S903). Herein, a time lag is present between the time when the corresponding information stored in the memory 11 of the group controller 1 is changed in S713 in FIG. 19 and the time when the corresponding information stored in the memory 41 of the hall operating panel 4 is changed in S714, so that the corresponding information stored in the memory 11 and the corresponding information stored in the memory 41 are different from each other in some cases. Therefore, the collation of ID numbers is accomplished not only by the hall operating panel 4 but also by the group controller 1.

If the coinciding ID number is absent in S903, the CPU 10 next sends the error screen display instruction to the hall operating panel 4 (S904). When the hall operating panel 4 receives this error screen display instruction from the group controller 1, the CPU 40 of the hall operating panel 4 next causes the display section 44 to display the error screen 104 shown in FIG. 12 (S905). On the other hand, if the coinciding ID number is present in S903, the CPU 10 next specifies the “call-back operation No. 2 elevator” as the special operation information related to this ID number by referring to the corresponding information given in Table 1 stored in the memory 11 (S906).

Next, the CPU 10 sends the call-back operation instruction to the elevator controller 30 of the elevator 3 specified from this special operation information (S907). Then, the elevator controller 30 of the elevator 3 that has received this call-back operation instruction operates the car 33 to the prescribed floor.

On the other hand, when the CPU 40 of the hall operating panel 4 specifies the “service floor cut operation” as the special operation information in S206 in FIG. 4, subsequently, the hall operating panel 4 and the group controller 1 start service floor cut operation processing shown in FIG. 22. FIG. 22 is a flowchart showing the service floor cut operation processing performed by the hall operating panel 4 and the group controller 1 in accordance with the second embodiment. First, the CPU 40 of the hall operating panel 4 causes the display section 44 to display the service floor cut operation floor input screen 109 shown in FIG. 17 (S1000). Next, the CPU 40 judges whether or not the cut-off floor information has been inputted (S1001). If the cut-off floor information has not been inputted, the CPU 40 next judges whether or not the predetermined time has elapsed after the ID number was inputted in S201 (S1002). If the predetermined time has not elapsed, the CPU returns to S1001. On the other hand, if the predetermined time has elapsed, the CPU 40 next causes the display section 44 to display the normal operation floor input screen 100 shown in FIG. 8, and starts the normal operation processing shown in FIG. 3.

If the cut-off floor information has been inputted in S1001, the CPU 40 next causes the display section 44 to display the service floor cut operation floor display screen 110 shown in FIG. 18 (S1003). Also, the CPU 40 sends this ID number and the cut-off floor information to the group controller 1 (S1004). When receiving this ID number and the cut-off floor information from the hall operating panel 4, the CPU 10 of the group controller 1 collates the received ID number with the plurality of ID numbers stored in advance in the memory 11 (S1005), and judges whether or not an ID number coinciding with this ID number is present (S1006). Herein, a time lag is present between the time when the corresponding information stored in the memory 11 of the group controller 1 is changed in S713 in FIG. 19 and the time when the corresponding information stored in the memory 41 of the hall operating panel 4 is changed in S714, so that the corresponding information stored in the memory 11 and the corresponding information stored in the memory 41 are different from each other in some cases. Therefore, the collation of ID numbers is accomplished not only by the hall operating panel 4 but also by the group controller 1.

If the ID number coinciding with the received ID number is absent in S1006, the CPU 10 next sends the error screen display instruction to the hall operating panel 4 (S1007). When the hall operating panel 4 receives this error screen display instruction from the group controller 1, the CPU 40 of the hall operating panel 4 next causes the display section 44 to display the error screen 104 shown in FIG. 12 (S1009). On the other hand, if the ID number coinciding with the received ID number is present in S1006, the CPU 10 of the group controller 1 next specifies the “service floor cut operation” as the special operation information related to this ID number by referring to the corresponding information given in Table 1 stored in the memory 11 (S1009).

Next, the CPU 10 sends the service floor cut operation instruction to the elevator controller 30 of the prescribed elevator 3 (S1110). Then, the elevator controller 30 of the elevator 3 that has received this service floor cut operation instruction cuts off the cut-off floor from the service objects.

After the ID number changing processing shown in FIG. 19 has been finished or after the special operation processing shown in FIG. 4 and FIGS. 20 to 22 has been finished, the hall operating panel 4 and the group controller 1 start the normal operation processing shown in FIG. 3.

In this embodiment, in the corresponding information given in Table 1, for the call-back operation, the special operation information consists of the name of special operation and the name of elevator. However, the special operation information may consist of only the name of special operation. In this case, by causing the person who inputted the ID number to input the elevator information, the elevator to be subjected to call-back operation is specified.

Also, in this embodiment, when the minus button of the ten-key pad 50a is pressed after the function button 51 on the hall operating panel 4 has been pressed, the ID number changing processing is started. However, the ID number changing processing may be started by any other operation using the function button 51. As such a special operation, for example, the function button 51 may be pressed two times continuously.

The function button 51 corresponds to the first input changeover means, and the above-described special operation using the function button 51 corresponds to a second input changeover means.

The corresponding information given in Table 1 stored in the memory 11 of the group controller 1 can also be changed directly without depending on the operation of the hall operating panel 4. In this case, not only the ID number is changed, but also the ID number and the special operation information can be added. The group controller 1 can be connected to an external device, and by sending new corresponding information from this external device to the group controller 1, the corresponding information stored in the memory 11 can be changed. After the corresponding information given in Table 1 stored in the memory 11 has been changed, the CPU 10 sends this new corresponding information to all of the hall operating panels 4a to 4c each time the corresponding information is changed or periodically. When receiving this new corresponding information from the group controller 1, each of the hall operating panels 4a to 4c changes the pre-change corresponding information stored in the memory 41 to the new corresponding information.

According to this embodiment, an elevator system provided with a hall operating panel that is low in cost and capable of giving various special operation instructions can be provided merely by adding one button (function button) to the conventional push button type hall operating panel using hardware contacts such as push buttons and key switches. Also, since an ID number can be changed by a special operation using the function button, an elevator system having great convenience can be provided.

1.-7. (canceled)

8. An elevator system comprising:
an elevator;
a hall operating panel which is provided in an elevator hall and has a destination floor input section; and
a controller for controlling the elevator based on the information inputted by the hall operating panel;
an ID number input section provided on the hall operating panel;
a first input changeover section which is provided on the hall operating panel to accomplish changeover so as to make the destination floor input section invalid and to make the ID number input section valid;
a storage device which stores corresponding information comprising a plurality of ID numbers and a plurality of pieces of special operation information related to each of the ID numbers;
a normal operation instructing section which gives a normal operation instruction to the elevator based on the destination floor information inputted by the destination floor input section;
a special operation information specifying section which specifies special operation information related to the inputted ID number based on the ID number inputted by the ID number input section and the corresponding information stored in the storage device; and
a special operation instructing section which gives a special operation instruction to the elevator based on the special operation information specified by the special operation information specifying section.

9. The elevator system according to claim 8, wherein
the elevator system further comprises a special operation object input section which is provided on the hall operating panel to input elevator information or floor information based on the special operation information specified by the special operation information specifying section, and
the special operation instructing section gives a special operation instruction to the elevator based on the special operation information specified by the special operation information specifying section and the elevator information or floor information inputted by the special operation object input section.

10. The elevator system according to claim 8, wherein the storage device and the special operation information specifying section are provided in the hall operating panel and the controller.

11. The elevator system according to claims 8, wherein the elevator system further comprises:
an ID number change input section which is provided on the hall operating panel to input the pre-change ID number and a new ID number;
an ID number changing section which changes the ID number in the corresponding information stored in the storage device based on the pre-change ID number and the new ID number inputted by the ID number change input section; and
a second input changeover section which is provided on the hall operating panel to accomplish changeover so as to make the destination floor input section and the ID number input section invalid and to make the ID number change input section valid.

12. The elevator system according to claim 9, wherein the elevator system further comprises:
an ID number change input section which is provided on the hall operating panel to input the pre-change ID number and a new ID number;
an ID number changing section which changes the ID number in the corresponding information stored in the storage device based on the pre-change ID number and the new ID number inputted by the ID number change input section; and
a second input changeover section which is provided on the hall operating panel to accomplish changeover so as to make the destination floor input section and the ID number input section invalid and to make the ID number change input section valid.

13. The elevator system according to claim 10, wherein the elevator system further comprises:
an ID number change input section which is provided on the hall operating panel to input the pre-change ID number and a new ID number;
an ID number changing section which changes the ID number in the corresponding information stored in the storage device based on the pre-change ID number and the new ID number inputted by the ID number change input section; and
a second input changeover section which is provided on the hall operating panel to accomplish changeover so as to make the destination floor input section and the ID number input section invalid and to make the ID number change input section valid.

14. A method for controlling an elevator system which controls an elevator based on the information inputted by a hall operating panel provided in an elevator hall, comprising:
a storing step of storing corresponding information comprising a plurality of ID numbers and a plurality of pieces of special operation information related to each of the ID numbers;
a first changeover judging step of judging whether or not a first input changeover signal has been inputted by the hall operating panel;
a destination floor judging step of judging, if it is judged in the first changeover judging step that the first input changeover signal has not been inputted, whether or not destination floor information has been inputted by the hall operating panel;
a normal operation instructing step of giving a normal operation instruction to the elevator based on the inputted destination floor information if it is judged in the destination floor judging step that the destination floor information has been inputted;
an ID number judging step of judging, if it is judged in the first changeover judging step that the first input changeover signal has been inputted, whether or not an ID number has been inputted by the hall operating panel;
a special operation information specifying step of specifying, if it is judged in the ID number judging step that the ID number has been inputted, special operation information related to the inputted ID number based on the inputted ID number and the corresponding information stored in the storing step; and
a special operation instructing step of giving a special operation instruction to the elevator based on the special operation information specified in the special operation information specifying step.

15. The method for controlling an elevator system according to claim 14, further comprising:
a special operation object judging step of judging, based on the special operation information specified in the special operation information specifying step, whether or not elevator information or floor information has been inputted, and
in the special operation instructing step, if it is judged in the special operation object judging step that the elevator information or floor information has been inputted, a special operation instruction is given to the elevator based on the elevator information or floor information inputted in the special operation object judging step and the special operation information specified in the special operation information specifying step.

16. The method for controlling an elevator system according to claim 14, further comprising:
a second changeover judging step of judging whether or not a second input changeover signal has been inputted by the hall operating panel;
an ID number change judging step of judging, if it is judged in the second changeover judging step that the second input changeover signal has been inputted, whether or not the pre-change ID number and a new ID number have been inputted by the hall operating panel; and
an ID number changing step of changing the ID number in the corresponding information stored in the storing step based on the pre-change ID number and the new ID number inputted in the ID number change judging step.
